(19) United States
(12) Patent Application Publication
(10) Pub. No.: US 2026/0111915 A1
(43) Pub. Date: Apr. 23, 2026

(54) METHOD FOR AUTOMATICALLY IDENTIFYING ABNORMAL POLLUTANT DISCHARGE PERMIT INFORMATION, APPARATUS, DEVICE, AND STORAGE MEDIUM

(71) Applicant: Appraisal Center for Environment & Engineering, Ministry of Ecology and Environment, Beijing (CN)

(72) Inventors: Haihong Xu, Beijing (CN); Lu Song, Beijing (CN); Xiaojun Lyu, Beijing (CN); Shaoyang Hao, Beijing (CN); Yunhui Du, Beijing (CN); Bo Li, Beijing (CN); Zhenlong Dong, Beijing (CN); Jinbei Fu, Beijing (CN); Xiaohui Li, Beijing (CN)

(21) Appl. No.: 19/365,127

(22) Filed: Oct. 21, 2025

(30) Foreign Application Priority Data
Oct. 21, 2024 (CN) 2024114655515

(51) Int. Cl. G06Q 30/018; G06N 3/047

(52) U.S. Cl. CPC G06Q 30/018; G06N 3/047

(57) ABSTRACT

A method for automatically identifying abnormal pollutant discharge permit information, an apparatus, a device, and a storage medium are provided. The method includes: using a Pearson correlation coefficient matrix derived from a dynamic time window to fit statistical distribution patterns, thereby determining key parameter pairs suitable for calculating ratio coefficients; calculating a ratio coefficient matrix within the dynamic time window; constructing an upper and lower edge value distribution function of ratio coefficients based on quantile regression; filtering multiple groups of quantile function parameters and selecting an optimal parameter group to serve as final quantile function parameters during actual use; and, when data anomalies are detected, calculating the ratio coefficients using submitted data, and determining whether the submitted data contains any abnormalities based on whether the calculated ratio coefficients fall within the upper and lower edge values predicted by the quantile distribution function.

### CROSS-REFERENCE TO RELATED APPLICATION

This application claims priority to Chinese patent application No. CN202411465551.5, filed to China National Intellectual Property Administration (CNIPA) on Oct. 21, 2024, which is herein incorporated by reference in its entirety.

### TECHNICAL FIELD

The disclosure relates to the field of data monitoring technologies, and in particular to a method for automatically identifying abnormal pollutant discharge permit information, an apparatus, a device, and a storage medium.

### BACKGROUND

Basic information about enterprises and relevant environmental management requirements must be reported in the discharge permit. The accuracy of the content filled in the discharge permit is crucial. In actual production processes, enterprises often make mistakes when reporting data, such as missing or incorrect entries, unit conversion errors, or subjective data fabrication. However, for personnel from specific industries, reviewing relevant industry content can be challenging, making it easy to make erroneous judgments.

### SUMMARY

The disclosure provides a method for automatically identifying abnormal pollutant discharge permit information, an apparatus, a device, and a storage medium, addressing the issue of frequent misjudgments and errors in reviewing the content submitted for pollutant discharge permits in the related art.

In a first aspect, the disclosure provides a method for automatically identifying abnormal pollutant discharge permit information, which includes:
obtaining key parameter pairs, where the key parameter pairs are selected from enterprise pollutant discharge permit filing information;
calculating, based on the key parameter pairs, a Pearson correlation coefficient matrix using a dynamic time window;
performing distribution statistics on the correlation coefficient matrix, and calculating a mathematical expectation and a confidence interval of correlation coefficients;
determining, based on the correlation coefficient matrix after the distribution statistics, the key parameter pairs that pass a distribution test, and based on the key parameter pairs passed the distribution test, calculating a ratio coefficient matrix using the dynamic time window, and calculating a mathematical expectation of the ratio coefficient matrix;
constructing an upper and lower edge value distribution function based on quantile regression of ratio coefficients;
filtering a plurality of groups of parameters for the upper and lower edge value distribution function of the ratio coefficients based on the key parameter pairs, the correlation coefficient matrix, the ratio coefficient matrix, and the mathematical expectation of the ratio coefficient matrix, and validating the plurality of groups of parameters to determine an optimal quantile distribution function; and
utilizing the optimal quantile distribution function to calculate upper and lower edge values (also referred to as upper and lower bounds) of the ratio coefficients for the key parameter pairs, and identifying the abnormal pollutant discharge permit information based on the upper and lower edge values.

In an embodiment, the method further includes that when the abnormal pollutant discharge permit information is detected, a pop-up window is displayed containing the abnormal pollutant discharge permit information and alerts to inform the handling personnel of the abnormal pollutant discharge permit information and prompt corrective actions, thereby improving the accuracy of the information submitted in the pollutant discharge permit.

In an embodiment, each key parameter pair includes a first key parameter and a second key parameter. The calculating, based on the key parameter pairs, a Pearson correlation coefficient matrix using a dynamic time window is expressed by the following formula:

$${ρ}_{x , {y}_{i = 1}^{m}} = \frac{{\sum }_{j = 1}^{n} ( {x}_{ij} - {μ}_{xi} ) ( {y}_{ij} - {μ}_{yi} )}{( n - 1 ) {σ}_{xi} {σ}_{yi}}$$

$${σ}_{xi} = \sqrt{\frac{{\sum }_{j = 1}^{n} {( {x}_{ij} - {μ}_{xi} )}^{2}}{n - 1}}$$

$${σ}_{yi} = \sqrt{\frac{{\sum }_{j = 1}^{n} {( {y}_{ij} - {μ}_{yi} )}^{2}}{n - 1}}$$

where

$${ρ}_{x , {y}_{i = 1}^{m}}$$

represents an element or the Pearson correlation coefficient matrix, xᵢⱼ represents the first key parameter of a j-th key parameter pair in an i-th dynamic time window, μₓᵢ represents an arithmetic mean value of the first key parameter in the i-th dynamic time window, n represents a length of the parameter pairs, j represents that calculation has reached the j-th parameter pair, yᵢⱼ represents the second key parameter of the j-th key parameter pair in the i-th dynamic time window, μ_{yi} represents an arithmetic mean value of the second key parameter in the i-th dynamic time window, σₓᵢ represents a variance of the first key parameter in the i-th dynamic time window, σ_{yi} represents a variance of the second key parameter in the i-th dynamic time window, and m represents a number of sliding windows.

In an embodiment, the performing distribution statistics on the correlation coefficient matrix, and calculating a mathematical expectation and a confidence interval of correlation coefficients includes:
performing fitting distribution on the correlation coefficient matrix based on a Gaussian distribution to obtain fitted data;
performing a distribution test based on a Kolmogorov-Smirnov (K-S) test on the fitted data, and when the distribution test passes, determining that the correlation coefficient matrix conforms to the Gaussian distribution, where the K-S test is calculated as follows:

$${D}_{n} = \begin{matrix}sup \\ x\end{matrix} \vert {F}_{n} ( x ) - F ( x ) \vert$$

where Dₙ represents statistic of the K-S test,

$$\begin{matrix}sup \\ x\end{matrix}$$

represents a supremum of a distance of a computed sequence, Fₙ(x) represents a value of a sequence to be tested, and F(x) represents a theoretical distribution sequence value;
for the correlation coefficient matrix conforming to the Gaussian distribution, calculating the mathematical expectation and confidence interval of the correlation coefficient matrix;
where the mathematical expectation is E(X)=μ, and the confidence interval is μ±σ, μ is a general expression for an arithmetic mean value, and σ represents a variance calculated from data.

In an embodiment, the determining, based on the correlation coefficient matrix after the distribution statistics, the key parameter pairs that pass a distribution test, and based on the key parameter pairs passed the distribution test, calculating a ratio coefficient matrix using the dynamic time window, and calculating a mathematical expectation of the ratio coefficient matrix includes:
taking the key parameter pairs corresponding to the correlation coefficient matrix that conforms to the Gaussian distribution as the key parameter pairs passed the distribution test;
based on the key parameter pairs passed the distribution test, calculating the ratio coefficient matrix K, where elements of K are composed of

$${k}_{x , {y}_{i = 1}^{m}} , {k}_{x , {y}_{i = 1}^{m}} = \frac{{\vec{x}}_{i}}{{\vec{y}}_{i}} ;$$

\vec{x}ᵢ represents a vector of the first key parameter in the key parameter pair, and \vec{y}ᵢ represents a vector of the second key parameter in the key parameter pair;
performing distribution fitting statistics on the ratio coefficient matrix to obtain a fitted ratio coefficient matrix, using one of the Gaussian distribution, a Poisson distribution, or an exponential distribution;
performing the distribution test on the fitted ratio coefficient matrix using any one of the K-S test, an Anderson-Darling (A-D) test, or a t-test; and
calculating the mathematical expectation of the ratio coefficient matrix passed the distribution test.

In an embodiment, the constructing an upper and lower edge value distribution function based on quantile regression of ratio coefficients includes:
constructing a neural network model targeting quantiles as the upper and lower edge value distribution function based on the quantile regression, where the neural network model takes the key parameter pairs, the correlation coefficient matrix, and the ratio coefficient matrix as inputs, and takes the upper and lower edge values of the ratio coefficients for the key parameter pairs as outputs; and
using a quantile loss function as a loss function of the neural network model, where a target value of the quantile loss function is the mathematical expectation of the ratio coefficient matrix, and the quantile loss function includes an individual quantile loss function and a grouped quantile loss function; and calculation formulas for the individual quantile loss function and the grouped quantile loss function are as follows:

$$loss ( {y}_{i} , {y}^{p} ) = q * max ( 0 , {y}_{i} - {y}^{p} ) + ( 1 - q )$$

$$loss ( y , {y}^{p} ) = \frac{1}{N} {\sum }_{i = 1}^{N} loss ( {y}_{i} , {y}^{p} )$$

where loss (yᵢ, y^{p}) represents the individual quantile loss function, y represents the target value, y^{p} represents a model predicted value, q represents a quantile level, yᵢ represents a single target value, loss (y, y^{p}) represents the grouped quantile loss function, N represents a total amount of the target value, and i represents that calculation has reached an i-th target value.

In an embodiment, the filtering a plurality of groups of parameters for the upper and lower edge value distribution function of the ratio coefficients based on the key parameter pairs, the correlation coefficient matrix, the ratio coefficient matrix, and the mathematical expectation of the ratio coefficient matrix, and validating the plurality of groups of parameters to determine an optimal quantile distribution function includes:
establishing a dataset based on the key parameter pairs, the correlation coefficient matrix, the ratio coefficient matrix, and the mathematical expectation of the ratio coefficient matrix;
dividing the dataset into a plurality of groups of training sets, testing sets, and validation sets; where the validation sets are randomly extracted from the dataset, and the target value of the quantile loss function is an overall mathematical expectation of the ratio coefficient matrix; the training sets and the testing sets are obtained via a sliding window from the remaining data after extracting the validation sets;
optimizing the parameters of the upper and lower edge value distribution function of the ratio coefficients using the training sets, and when an evaluation metric of the upper and lower edge value distribution function of the ratio coefficients on the testing sets meets a standard, determining filtered parameters and proceeding to filter a next group of parameters; and
for a plurality of filtered parameters of the upper and lower edge value distribution function of the ratio coefficients, validating, on the validation sets, evaluation metrics of the plurality of filtered parameters of the upper and lower edge value distribution function of the ratio coefficients, selecting one group of parameters with an optimal evaluation metric as target parameters, configuring the upper and lower edge value distribution function of the ratio coefficients with the target parameters, and thereby obtaining the optimal quantile distribution function;
where the evaluation metric is prediction interval coverage probability (PICP), with confidence level PINC, and the calculation formula is as follows:

$$PICP = \frac{1}{N} {\sum }_{i = 1}^{N} {c}_{i}$$

$${c}_{i} = \{ \begin{matrix}1 , & {y}_{i} ∈ [ L , U ] \\ 0 , & {y}_{i} ∉ [ L , U ]\end{matrix}$$

$$PINC = 100 ( 1 - α ) \%$$

where L represents a predicted lower edge value, U represents a predicted upper edge value, N represents a total amount of computed data, i represents an i-th data point, cᵢ represents a numerical expression indicating whether an actual value falls within a predicted interval, yᵢ represents an i-th actual value, and α represents a confidence level, typically set at 0.05 or 0.1.

In a second aspect, the disclosure provides an apparatus for automatically identifying abnormal pollutant discharge permit information, including:
a data acquisition module, configured to obtain key parameter pairs, where the key parameter pairs are selected from enterprise pollutant discharge permit filing information, and each key parameter pair includes a first key parameter and a second key parameter;
a first calculation module, configured to calculate, based on the key parameter pairs, a Pearson correlation coefficient matrix using a dynamic time window;
a distribution verification module, configured to perform distribution statistics on the correlation coefficient matrix, and calculating a mathematical expectation and a confidence interval of correlation coefficients;
a second calculation module, configured to determine, based on the correlation coefficient matrix after the distribution statistics, the key parameter pairs that pass a distribution test, and based on the key parameter pairs passed the distribution test, calculating a ratio coefficient matrix using the dynamic time window, and calculating a mathematical expectation of the ratio coefficient matrix;
a function construction module, configured to an upper and lower edge value distribution function based on quantile regression of ratio coefficients;
a function training module, configured to filter a plurality of groups of parameters for the upper and lower edge value distribution function of the ratio coefficients based on the key parameter pairs, the correlation coefficient matrix, the ratio coefficient matrix, and the mathematical expectation of the ratio coefficient matrix, and validating the plurality of groups of parameters to determine an optimal quantile distribution function; and
an anomaly identification module, configured to utilize the optimal quantile distribution function to calculate upper and lower edge values of the ratio coefficients for the key parameter pairs, and identifying the abnormal pollutant discharge permit information based on the upper and lower edge values.

In a third aspect, the disclosure provides an electronic device including: at least one processor and a memory; the memory stores computer-executable instructions; and the at least one processor executes the computer-executable instructions stored in the memory, thereby causing the at least one processor to perform the method for automatically identifying abnormal pollutant discharge permit information as described in the first aspect and in various possible designs of the first aspect.

In a fourth aspect, the disclosure provides a non-transitory computer-readable storage medium storing computer-executable instructions, which, when executed by a processor, implement the method for automatically identifying abnormal pollutant discharge permit information as described in the first aspect and in various possible designs outlined in the first aspect.

In a fifth aspect, the disclosure provides a computer program product includes a computer program that, when executed by a processor, implements the automatic identification method for abnormal discharge permit information as described in the first aspect and in various possible designs outlined in the first aspect.

The disclosure provides the method for automatically identifying abnormal pollutant discharge permit information, the apparatus, the device, and the storage medium. By using the Pearson correlation coefficient matrix within the dynamic time window to fit statistical distribution patterns, the method determines key parameter pairs suitable for calculating ratio coefficients, calculates the ratio coefficient matrix for the dynamic time window, constructs the upper and lower edge value distribution function of ratio coefficients based on quantile regression, filters multiple groups of quantile function parameters and selects the optimal parameter group to serve as final quantile function parameters during actual use, when data anomalies are detected, calculates the ratio coefficients using submitted data, and determines whether the submitted data contains any abnormalities based on whether the calculated ratio coefficients fall within the upper and lower edge values predicted by the quantile distribution function. This provides a basis for fundamental data review in the steel industry and supports data auditing in other industries.

### BRIEF DESCRIPTION OF DRAWINGS

The accompanying drawings herein are incorporated into the specification and form part of the specification, illustrating embodiments consistent with the disclosure and, together with the specification, serving to explain the principles underlying the application.

FIG. 1 is a flowchart of a method for automatically identifying abnormal pollutant discharge permit information according to an embodiment of the disclosure.

FIG. 2 is a flowchart illustrating a filtering process for determining an upper and lower edge value distribution function of a group of ratio coefficients according to the embodiment of the disclosure.

FIG. 3 is a frequency histogram showing distribution test results of Pearson correlation coefficients for a group of key parameter pairs according to the embodiment of the disclosure.

FIG. 4 is a quartile box plot showing the ratio coefficients of multiple groups of key parameter pairs according to the embodiment of the disclosure.

FIG. 5 is a schematic structural diagram of an apparatus for automatically identifying abnormal pollutant discharge permit information according to an embodiment of the disclosure.

FIG. 6 is a schematic structural diagram of an electronic device according to an embodiment of the disclosure.

The specific embodiments of the disclosure have been illustrated through the above figures, with more detailed descriptions provided later in the text. These drawings and textual descriptions are not intended to limit the scope of the inventive concept of the disclosure in any way, but rather serve to explain the concepts of the disclosure to those skilled in the art by reference to specific embodiments.

### DETAILED DESCRIPTION OF EMBODIMENTS

Here, exemplary embodiments will be described in detail, with their examples illustrated in the accompanying drawings. When referring to the drawings, unless stated otherwise, the same numbers in different drawings represent identical or similar elements. The implementations described in these exemplary embodiments do not represent all implementations consistent with the disclosure. On the contrary, they are merely examples of devices and methods consistent with some aspects detailed in the claims of the disclosure.

In technical solutions of the disclosure, the collection, storage, use, processing, transmission, provision, and disclosure of information such as financial data or user data comply with relevant laws and regulations, and do not violate public order and good morals.

It should be noted that in the embodiments of the disclosure, certain software, components, models, or other existing industry solutions may be mentioned. These references are exemplary and intended solely to illustrate the feasibility of implementing the technical solutions of the disclosure, but this does not mean that the disclosure has necessarily used or will inevitably use these solutions.

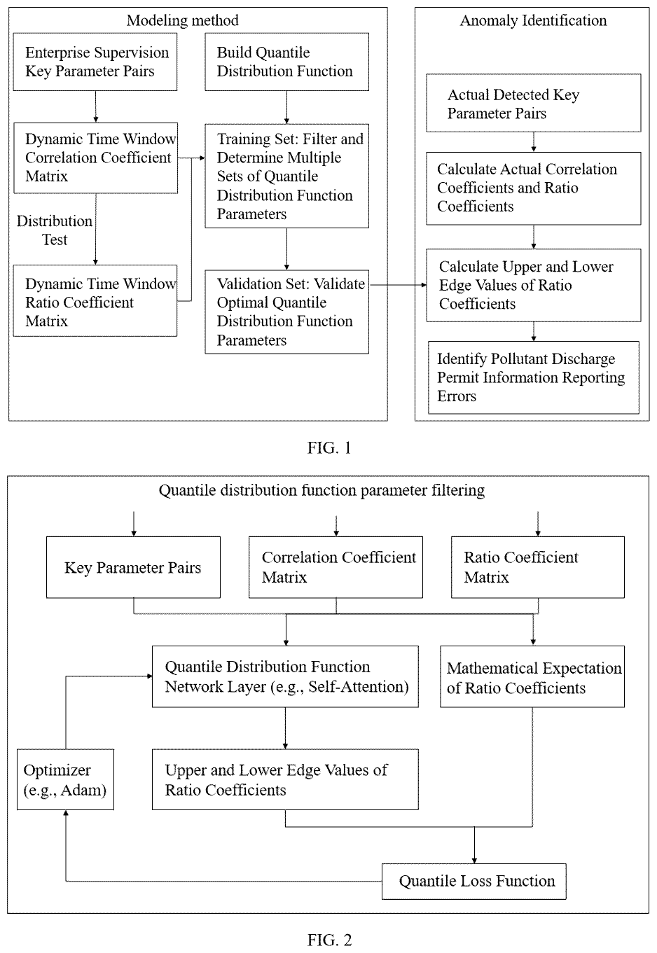

An embodiment of the disclosure provides a method for automatically identifying abnormal pollutant discharge permit information. FIG. 1 is a flowchart illustrating a method for automatically identifying abnormal pollutant discharge permit information according to an embodiment of the disclosure. As shown in FIG. 1, the method for automatically identifying abnormal pollutant discharge permit information includes:

S1: Obtaining key parameter pairs, where the key parameter pairs are selected from enterprise pollutant discharge permit filing information.

In this embodiment, taking the steel industry as an example, the key parameters include a pair of key parameters. These key parameters are selected from enterprise pollutant discharge permit filing information in the relevant industry and are presented as at least two sets of corresponding sequential data, expressed as:

$$A ( X , Y ) = [ \begin{matrix}\vec{x} \\ \vec{y}\end{matrix} ] ,$$

where X, Y respectively represent one key parameter, and \vec{x} and \vec{y} denote the feature vectors corresponding to the key parameters X and Y, respectively.

In one embodiment, the steel industry is selected, and the key parameters include sinter usage, iron concentrate usage, coke usage, molten iron production, crude steel production, hot-rolled product production, and power generation. The key parameter pairs are formed by all possible combinations of two different key parameters, for example, the pair of crude steel production and sinter usage.

S2: Calculating, based on the key parameter pairs, a Pearson correlation coefficient matrix using a dynamic time window.

In some embodiments, step S2 specifically includes steps as follows.

S21: For the paired data A(X, Y) of the aforementioned key parameter pairs, a dynamic time window takes m sets of data, denoted as

$${A}_{i = 1}^{m} ( {X}_{i} , {Y}_{i} ) = [ \begin{matrix}\vec{x} \\ \vec{y}\end{matrix} ] ,$$

where Xᵢ and Yᵢ represent the two key parameters in the i-th key parameter pair. Here, Xᵢ and Yᵢ refer to the first and second key parameters, respectively, and \vec{x}ᵢ and \vec{y}ᵢ denote the feature vectors corresponding to the key parameters Xᵢ and Yᵢ, respectively.

S22: For the obtained multiple sets of data

$${A}_{i = 1}^{m} ( {X}_{i} , {Y}_{i} ) ,$$

the matrix R of m groups of Pearson correlation coefficients is calculated. The elements of matrix R are formed by

$${ρ}_{x , {y}_{i = 1}^{m}} ,$$

and a significance test is performed on these correlation coefficients. Only those Pearson correlation coefficients that pass the significance test are included in the dynamic time window correlation coefficient matrix R. The formula for calculating the Pearson correlation coefficient is as follows:

$${ρ}_{x , {y}_{i = 1}^{m}} = \frac{{\sum }_{j = 1}^{n} ( {x}_{ij} - {μ}_{xi} ) ( {y}_{ij} - {μ}_{yi} )}{( n - 1 ) {σ}_{xi} {σ}_{yi}}$$

$${σ}_{xi} = \sqrt{\frac{{\sum }_{j = 1}^{n} {( {x}_{ij} - {μ}_{xi} )}^{2}}{( n - 1 )}}$$

$${σ}_{yi} = \sqrt{\frac{{\sum }_{j = 1}^{n} {( {y}_{ij} - {μ}_{yi} )}^{2}}{( n - 1 )}}$$

In this formula,

$${ρ}_{x , {y}_{i = 1}^{m}}$$

represents an element or me Pearson correlation coefficient matrix, xᵢⱼ represents the first key parameter of a j-th key parameter pair in an i-th dynamic time window, μₓᵢ represents an arithmetic mean value of the first key parameter in the i-th dynamic time window, n represents a length of the parameter pairs, j represents that calculation has reached the j-th parameter pair, yᵢⱼ represents the second key parameter of the j-th key parameter pair in the i-th dynamic time window, μ_{yi} represents an arithmetic mean value of the second key parameter in the i-th dynamic time window, σₓᵢ represents a variance of the first key parameter in the i-th dynamic time window, σ_{yi} represents a variance of the second key parameter in the i-th dynamic time window, and m represents a number of sliding windows.

S3: Performing distribution statistics on the correlation coefficient matrix, and calculating a mathematical expectation and a confidence interval of correlation coefficients.

In some embodiments, step S3 specifically includes steps as follows.

S31: The correlation matrix of the dynamic time window is statistically analyzed and fitted to common distributions.

In one embodiment, a Gaussian distribution X˜N(μ, σ²) is fitted. During the fitting process, μ is calculated by the mean value of the data, and σ is calculated by the standard deviation of the data.

S32: The distribution test is performed on the data fitted to the distribution.

In one embodiment, the K-S test is used. When the distribution test passes, the correlation coefficient matrix conforms to the Gaussian distribution is determined, and the K-S test is calculated as follows:

$${D}_{n} = \begin{matrix}sup \\ x\end{matrix} \vert {F}_{n} ( x ) - F ( x ) \vert$$

In this formula, Dₙ represents statistic of the K-S test,

$$\begin{matrix}sup \\ x\end{matrix}$$

distance of a computed sequence, Fₙ(x) represents a value of a sequence to be tested, and F(x) represents a theoretical distribution sequence value.

S33: For the correlation coefficient matrix conforming to the Gaussian distribution, its expected value and confidence interval are calculated.

For example, for a correlation parameter array that follows the Gaussian distribution, the mathematical expectation is E(X)=μ, with a confidence interval of μ±σ.

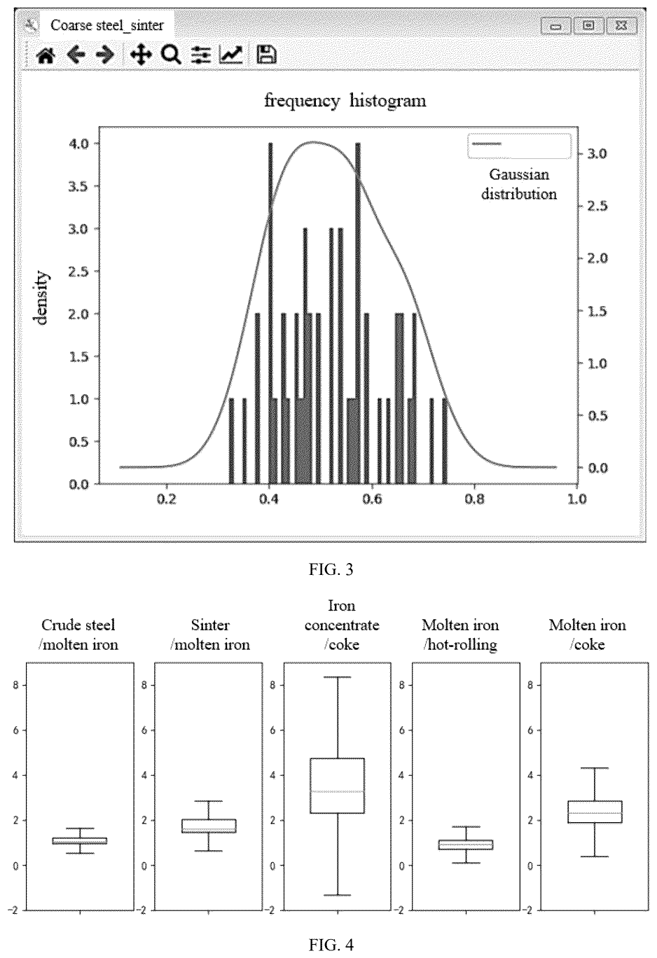

Taking the steel industry as an example, as shown in FIG. 3, FIG. 3 is a frequency histogram showing distribution test results of Pearson correlation coefficients for a group of key parameter pairs. Specifically, although the actual computational steps depend on the data distribution test and its significance indicators conducted, in the case of Gaussian distribution testing and fitting, the frequency histogram shown in the FIG. 3 can be used for intuitive visualization of the data distribution. The frequency histogram in FIG. 3 represents the result under a bin count of 50. The ordinate on the left corresponds to the frequency of the histogram bars. The curve and other coordinates shown represent a probability density plot (using kde, Kernel Density Estimation plot), where the curve is actually the kernel density curve (through the distribution test operation in the step, it can be known that the data distribution has passed the hypothesis test of Gaussian distribution), and the ordinate on the right represents the probability density value, which can be derived from the integral of the area under the kernel density curve as 1 if calculated manually. The abscissa represents the actual values of the Pearson correlation coefficients measured from the dataset (i.e., the values of the key parameter pairs of the Pearson correlation coefficients participating in the representation of the distribution are shown in FIG. 3, so the numerical range lies between 0 and 1).

S4: Determining, based on the correlation coefficient matrix after the distribution statistics, the key parameter pairs that pass a distribution test, and based on the key parameter pairs passed the distribution test, calculating a ratio coefficient matrix using the dynamic time window, and calculating a mathematical expectation of the ratio coefficient matrix.

In some embodiments, step S4 specifically includes steps as follows.

S41: For the key parameter pairs that pass the distribution test, the ratio coefficient matrix K is calculated, and elements of K are composed of

$${k}_{x , {y}_{i = 1}^{m}} , {k}_{x , {y}_{i = 1}^{m}} = \frac{{\vec{x}}_{i}}{{\vec{y}}_{i}} .$$

S42: The dynamic time window ratio coefficient matrix is statistically analyzed and fitted to common distributions.

In one embodiment, a Gaussian distribution X˜N(μ, σ²) is fitted. During the fitting process, μ is calculated by the mean value of the data, and σ is calculated by the standard deviation of the data.

S43: The distribution test is performed on the data fitted to the distribution.

In one embodiment, the fitting K-S test can also be replaced by other distribution test methods such as A-D test and t test. If the calculation hypothesis test is passed, it means that the ratio coefficient array conforms to the distribution. The calculation formula of the K-S test is as follows:

$${D}_{n} = \begin{matrix}sup \\ x\end{matrix} \vert {F}_{n} ( x ) - F ( x ) \vert$$

In this formula, Dₙ represents statistic of the K-S test,

$$\begin{matrix}sup \\ x\end{matrix}$$

represents a supremum of a distance of a computed sequence, Fₙ(x) represents a value of a sequence to be tested, and F(x) represents a theoretical distribution sequence value.

S44: For the correlation coefficient matrix conforming to the Gaussian distribution, its expected value and confidence interval are calculated.

For example, for a correlation parameter array that follows the Gaussian distribution, the mathematical expectation is E(X)=μ, with a confidence interval of μ±σ.

Taking the steel industry as an example, as shown in FIG. 4 is a quartile box plot showing the ratio coefficients of multiple groups of key parameter pairs.

S5, Constructing an upper and lower edge value distribution function based on quantile regression of ratio coefficients.

In some embodiments, step S5 specifically includes:

S51: a neural network model targeting quantiles is constructed as the upper and lower edge value distribution function based on the quantile regression. The neural network model takes the key parameter pairs, the correlation coefficient matrix, and the ratio coefficient matrix as inputs, and takes the upper and lower edge values of the ratio coefficients for the key parameter pairs as outputs.

This neural network model can be any neural network architecture that supports multi-layer networks. In one embodiment, network layers of the regression model are constructed using a Self-Attention structure.

S52: A quantile loss function is used as a loss function of the neural network model, a target value of the quantile loss function is the mathematical expectation of the ratio coefficient matrix, and the quantile loss function includes an individual quantile loss function and a grouped quantile loss function; and calculation formulas for the individual quantile loss function and the grouped quantile loss function are as follows:

$$loss ( {y}_{i} , {y}^{p} ) = q * max ( 0 , {y}_{i} - {y}^{p} ) + ( 1 - q )$$

$$loss ( y , {y}^{p} ) = \frac{1}{N} {\sum }_{i = 1}^{N} loss ( {y}_{i} , {y}^{p} )$$

In this formula, loss (yᵢ, y^{p}) represents the individual quantile loss function, y represents the target value, y^{p} represents a model predicted value, q represents a quantile level, yᵢ represents a single target value, loss (y, y^{p}) represents the grouped quantile loss function, N represents a total amount of the target value, and i represents that calculation has reached an i-th target value.

The quantile level ranges between 0 and 1. In one embodiment, the value is set to 0.5.

The parameters of the neural network model are adjusted by any neural network optimizer. In one embodiment, the Adam optimizer is used as the feedback algorithm for parameter adjustment during neural network training.

S6: Filtering a plurality of groups of parameters for the upper and lower edge value distribution function of the ratio coefficients based on the key parameter pairs, the correlation coefficient matrix, the ratio coefficient matrix, and the mathematical expectation of the ratio coefficient matrix, and validating the plurality of groups of parameters to determine an optimal quantile distribution function.

In some embodiments, as shown in FIG. 2, FIG. 2 is a flowchart illustrating a filtering process for determining an upper and lower edge value distribution function of a group of ratio coefficients. Step S6 specifically includes steps as follows.

S61: A dataset is established based on the key parameter pairs, the correlation coefficient matrix, the ratio coefficient matrix, and the mathematical expectation of the ratio coefficient matrix.

S62: Based on the dataset, dataset is divided into multiple training, testing, and validation sets. The validation sets are randomly extracted from the dataset, and the target value of the quantile loss function is an overall mathematical expectation of the ratio coefficient matrix; the training sets and the testing sets are obtained via a sliding window from the remaining data after extracting the validation sets.

In one embodiment, the training sets and the test sets are obtained from the remaining data after extracting the validation sets from the dataset. The sliding window is used to obtain m groups of data, with each group being proportionally split, for example, 70% as the training set and 30% as the test set. The target value of the quantile loss function for each group's training set is the mathematical expectation of the ratio coefficient of that group's training set, and the target value of the quantile loss function for each group's test set is the mathematical expectation of the ratio coefficient of that group's test set.

S63: the parameters of the upper and lower edge value distribution function for the ratio coefficient are optimized using the training sets. When an evaluation metric of the upper and lower edge value distribution function of the ratio coefficients on the testing sets meets a standard, filtered parameters are determined and proceeding to filter a next group of parameters. Here, “meets a standard” means achieving the specified evaluation metric value; if the metric fails to reach the specified evaluation metric value, the function is considered “not meeting the standard”.

S64: For multiple filtered parameters of the upper and lower edge value distribution function of the ratio coefficients, evaluation metrics of the multiple filtered parameters of the upper and lower edge value distribution function of the ratio coefficients are validated on the validation sets, one group of parameters with an optimal evaluation metric as target parameters is selected, and the upper and lower edge value distribution function of the ratio coefficients with the target parameters is configured, thereby obtaining the optimal quantile distribution function.

The evaluation metric is prediction interval coverage probability (PICP), with a prediction interval confidence level (PINC), and the calculation formula is as follows:

$$PICP = \frac{1}{N} {\sum }_{i = 1}^{N} {c}_{i}$$

$${c}_{i} = \{ \begin{matrix}1 , & {y}_{i} ∈ [ L , U ] \\ 0 , & {y}_{i} ∉ [ L , U ]\end{matrix}$$

$$PINC = 100 ( 1 - α ) \%$$

In this formula, L represents a predicted lower edge value, U represents a predicted upper edge value, N represents a total amount of computed data, i represents an i-th data point, cᵢ represents a numerical expression indicating whether an actual value falls within a predicted interval, yᵢ represents an i-th actual value, and α represents a confidence level, typically set at 0.05 or 0.1.

S7: Utilizing the optimal quantile distribution function to calculate upper and lower edge values of the ratio coefficients for the key parameter pairs, and identifying the abnormal pollutant discharge permit information based on the upper and lower edge values.

In this embodiment, in actual implementation, the specific process of identifying the abnormal pollutant discharge permit information by using the upper and lower edge values is as follows. Based on the selected key parameter pair, the data of the pollutant discharge permit to be identified is obtained, the ratio coefficient and the Pearson correlation coefficient of the data are calculated, the key parameter pair to be identified, the ratio coefficient and the correlation coefficient of the key parameter pair to be identified are taken as the input of a quantile regression model. The upper and lower edge values of the ratio coefficient are calculated by the model. If the ratio coefficient of the identified key parameter pair is not within the upper and lower edge values, it is considered that there is an error in filling in the pollutant discharge permit data.

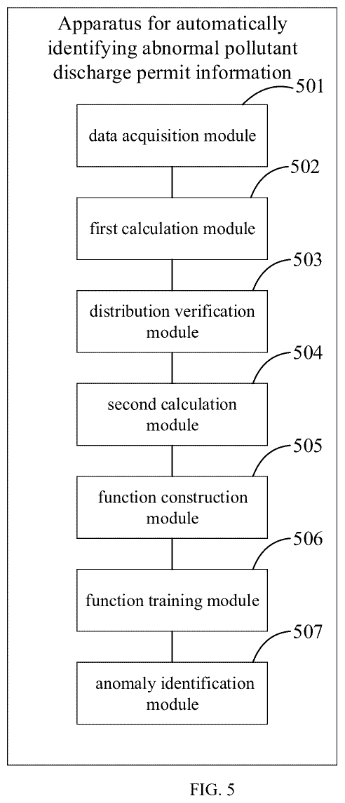

FIG. 5 is a schematic structural diagram of an apparatus for automatically identifying abnormal pollutant discharge permit information according to an embodiment of the disclosure. This embodiment of the disclosure also provides an apparatus for automatically identifying abnormal pollutant discharge permit information. As shown in FIG. 5, the apparatus includes:
a data acquisition module 501, configured to obtain key parameter pairs, where the key parameter pairs are selected from enterprise pollutant discharge permit filing information, and each key parameter pair includes a first key parameter and a second key parameter;
a first calculation module 502, configured to calculate, based on the key parameter pairs, a Pearson correlation coefficient matrix using a dynamic time window;
a distribution verification module 503, configured to perform distribution statistics on the correlation coefficient matrix, and calculating a mathematical expectation and a confidence interval of correlation coefficients;
a second calculation module 504, configured to determine, based on the correlation coefficient matrix after the distribution statistics, the key parameter pairs that pass a distribution test, and based on the key parameter pairs passed the distribution test, calculating a ratio coefficient matrix using the dynamic time window, and calculating a mathematical expectation of the ratio coefficient matrix;
a function construction module 505, configured to an upper and lower edge value distribution function based on quantile regression of ratio coefficients;
a function training module 506, configured to filter a plurality of groups of parameters for the upper and lower edge value distribution function of the ratio coefficients based on the key parameter pairs, the correlation coefficient matrix, the ratio coefficient matrix, and the mathematical expectation of the ratio coefficient matrix, and validating the plurality of groups of parameters to determine an optimal quantile distribution function; and
an anomaly identification module 507, configured to utilize the optimal quantile distribution function to calculate upper and lower edge values of the ratio coefficients for the key parameter pairs, and identifying the abnormal pollutant discharge permit information based on the upper and lower edge values.

In some embodiments, the first computation module is further configured to calculate, based on the key parameter pairs, the Pearson correlation coefficient matrix using the dynamic time window according to the following formula:

$${ρ}_{x , {y}_{i = 1}^{m}} = \frac{{\sum }_{j = 1}^{n} ( {x}_{ij} - {μ}_{xi} ) ( {y}_{ij} - {μ}_{yi} )}{( n - 1 ) {σ}_{xi} {σ}_{yi}}$$

$${σ}_{xi} = \sqrt{\frac{{\sum }_{j = 1}^{n} {( {x}_{ij} - {μ}_{xi} )}^{2}}{n - 1}}$$

$${σ}_{yi} = \sqrt{\frac{{\sum }_{j = 1}^{n} ( {y}_{ij} - {μ}_{yi} )}{n - 1}}$$

In this formula,

$${ρ}_{x , {y}_{i = 1}^{m}}$$

represents an element of the Pearson correlation coefficient matrix, xᵢⱼ represents the first key parameter of a j-th key parameter pair in an i-th dynamic time window, μₓᵢ represents an arithmetic mean value of the first key parameter in the i-th dynamic time window, n represents a length of the parameter pairs, j represents that calculation has reached the j-th parameter pair, yᵢⱼ represents the second key parameter of the j-th key parameter pair in the i-th dynamic time window, μ_{yi} represents an arithmetic mean value of the second key parameter in the i-th dynamic time window, σₓᵢ represents a variance of the first key parameter in the i-th dynamic time window, σ_{yi} represents a variance of the second key parameter in the i-th dynamic time window, and m represents a number of sliding windows.

In some embodiments, the distribution verification module is further configured to fit the distribution of the correlation coefficient matrix based on the Gaussian distribution

Based on the K-S test, the distribution test is performed on the data obtained from the fitted distribution. If the distribution test passes, it indicates that the correlation coefficient matrix follows the Gaussian distribution. The formula for the K-S test is as follows:

$${D}_{n} = \begin{matrix}sup \\ x\end{matrix} \vert {F}_{n} ( x ) - F ( x ) \vert$$

In this formula, Dₙ represents statistic of the K-S test,

$$\begin{matrix}sup \\ x\end{matrix}$$

represents a supremum of a distance of a computed sequence, Fₙ(x) represents a value of a sequence to be tested, and F(x) represents a theoretical distribution sequence value.

For the correlation coefficient matrix conforming to the Gaussian distribution, its expected value and confidence interval are calculated. The mathematical expectation is E(X)=μ, with a confidence interval of μ±σ, μ is a general expression for an arithmetic mean value, and σ represents a variance calculated from data.

In some embodiments, the second calculation module is further configured to:
take the key parameter pairs corresponding to the correlation coefficient matrix that conforms to the Gaussian distribution as the key parameter pairs passed the distribution test;
based on the key parameter pairs passed the distribution test, calculate the ratio coefficient matrix K, where elements of K are composed of

$${k}_{x , {y}_{i = 1}^{m}} , {k}_{x , {y}_{i = 1}^{m}} = \frac{{\vec{x}}_{i}}{{\vec{y}}_{i}} ;$$

\vec{x}ᵢ represents a vector of the first key parameter in the key parameter pair, and \vec{y}ᵢ represents a vector of the second key parameter in the key parameter pair;
perform distribution fitting statistics on the ratio coefficient matrix to obtain a fitted ratio coefficient matrix, using one of the Gaussian distribution, a Poisson distribution, or an exponential distribution;
perform the distribution test on the fitted ratio coefficient matrix using any one of the K-S test, a A-D test, or a t-test; and
calculate the mathematical expectation of the ratio coefficient matrix passed the distribution test.

In some embodiments, the function construction module is further configured to:
construct a neural network model targeting quantiles as the upper and lower edge value distribution function based on the quantile regression, where the neural network model takes the key parameter pairs, the correlation coefficient matrix, and the ratio coefficient matrix as inputs, and takes the upper and lower edge values of the ratio coefficients for the key parameter pairs as outputs; and
use a quantile loss function as a loss function of the neural network model, where a target value of the quantile loss function is the mathematical expectation of the ratio coefficient matrix, and the quantile loss function includes an individual quantile loss function and a grouped quantile loss function; and calculation formulas for the individual quantile loss function and the grouped quantile loss function are as follows:

$$loss ( {y}_{i} , {y}^{p} ) = q * max ( 0 , {y}_{i} - {y}^{p} ) + ( 1 - q )$$

$$loss ( y , {y}^{p} ) = \frac{1}{N} {\sum }_{i = 1}^{N} loss ( {y}_{i} , {y}^{p} )$$

In this formula, loss (yᵢ, y^{p}) represents the individual quantile loss function, y represents the target value, y^{p} represents a model predicted value, q represents a quantile level, yᵢ represents a single target value, loss (y, y^{p}) represents the grouped quantile loss function, N represents a total amount of the target value, and i represents that calculation has reached an i-th target value.

In some embodiments, the function training module is further configured to:
establish a dataset based on the key parameter pairs, the correlation coefficient matrix, the ratio coefficient matrix, and the mathematical expectation of the ratio coefficient matrix;
divide the dataset into a plurality of groups of training sets, testing sets, and validation sets; where the validation sets are randomly extracted from the dataset, and the target value of the quantile loss function is an overall mathematical expectation of the ratio coefficient matrix; the training sets and the testing sets are obtained via a sliding window from the remaining data after extracting the validation sets;
optimize the parameters of the upper and lower edge value distribution function of the ratio coefficients using the training sets, and when an evaluation metric of the upper and lower edge value distribution function of the ratio coefficients on the testing sets meets a standard, determine filtered parameters and proceeding to filter a next group of parameters; and
for a plurality of filtered parameters of the upper and lower edge value distribution function of the ratio coefficients, validate, on the validation sets, evaluation metrics of the plurality of filtered parameters of the upper and lower edge value distribution function of the ratio coefficients, select one group of parameters with an optimal evaluation metric as target parameters, configure the upper and lower edge value distribution function of the ratio coefficients with the target parameters, thereby obtaining the optimal quantile distribution function.

The evaluation metric is PICP, with PINC, and the calculation formula is as follows:

$$PICP = \frac{1}{N} {\sum }_{i = 1}^{N} {c}_{i}$$

$${c}_{i} = \{ \begin{matrix}1 , & {y}_{i} ∈ [ L , U ] \\ 0 , & {y}_{i} ∉ [ L , U ]\end{matrix}$$

$$PINC = 100 ( 1 - α ) \%$$

In this formula, L represents a predicted lower edge value, U represents a predicted upper edge value, N represents a total amount of computed data, i represents an i-th data point, cᵢ represents a numerical expression indicating whether an actual value falls within a predicted interval, yᵢ represents an i-th actual value, and α represents a confidence level typically set at 0.05 or 0.1.

The apparatus for automatically identifying abnormal pollutant discharge permit information according to the embodiment of the disclosure can be used to implement the technical solution for the method for automatically identifying abnormal pollutant discharge permit information described in the aforementioned embodiment. Its underlying principle and technical effects are similar, so further details will not be repeated herein.

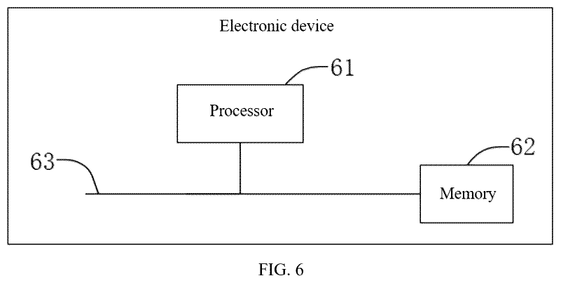

FIG. 6 is a schematic structural diagram of an electronic device according to an embodiment of the disclosure. As shown in FIG. 6, the electronic device may include: a processor 61 and a memory 62, which are communicatively connected; for example, the processor 61 and the memory 62 communicate via a communication bus 63.

The processor 61 executes computer-executable instructions stored in the memory 62, causing the processor 61 to execute the solutions described in the foregoing embodiments. The processor 61 may be a general-purpose processor, including a Central Processing Unit (CPU), a network processor (NP), etc. It may also be a Digital Signal Processor (DSP), an Application-Specific Integrated Circuit (ASIC), a Field-Programmable Gate Array (FPGA), or other programmable logic device, discrete gate or transistor logic device, or discrete hardware component.

The communication bus 63 may be a Peripheral Component Interconnect (PCI) bus, an Extended Industry Standard Architecture (EISA) bus, etc. The system bus can be divided into an address bus, a data bus, a control bus, etc. For ease of representation, the figure uses only one thick line, which does not imply that there is only one bus or one type of bus. A transceiver is used to enable communication between the database access device and other computers (such as clients, read-write libraries, and read-only libraries). The memory may include Random Access Memory (RAM) and may also include Non-Volatile Memory (NVM).

The electronic device according to the embodiment of the disclosure may be the terminal device described in the foregoing embodiments.

This embodiment of the disclosure also provides a non-transitory computer-readable storage medium. The computer-readable storage medium stores computer instructions, which, when run on a computer, cause the computer to execute the technical solution of the method for automatically identifying abnormal pollutant discharge permit information described in the foregoing embodiments.

This embodiment of the disclosure also provides a computer program product, which includes a computer program stored in a computer-readable storage medium. At least one processor can read the computer program from the computer-readable storage medium, and when executing the computer program, the at least one processor can implement the technical solution of the method for automatically identifying abnormal pollutant discharge permit information described in the foregoing embodiments.

In the several embodiments provided in the disclosure, it should be understood that the disclosed devices and methods can be implemented in other ways. For instance, the apparatus embodiment described above are merely illustrative. For example, the division of modules is merely a logical functional division, and in actual implementation, there may be other division methods. For example, multiple modules may be combined or integrated into another system, or some features may be omitted or not executed. Additionally, the mutual coupling or direct coupling or communication connections shown or discussed may be indirect coupling or communication connections through some interfaces, devices, or modules, which may be electrical, mechanical, or in other forms.

The modules described as separate components may or may not be physically separated, and the components displayed as modules may or may not be physical units. That is, they may be located in one place or distributed across multiple network units. Some or all of the modules may be selected according to actual needs to achieve the objectives of the solutions of the embodiments.

Additionally, the functional modules in the various embodiments of the disclosure may be integrated into one processing unit, or each module may exist physically separately, or two or more modules may be integrated into one unit. The modules integrated as described above may be implemented in the form of hardware or in the form of hardware combined with software functional units.

The integrated modules implemented in the form of software functional modules may be stored in a computer-readable storage medium. The software functional modules stored in a storage medium include several instructions for causing a computer device (which may be a personal computer, a server, a network device, etc.) or a processor to execute some of the steps of the methods described in the various embodiments of the disclosure.

It should be understood that the aforementioned processor may be a Central Processing Unit (CPU), or it may be another general-purpose processor, a Digital Signal Processor (DSP), an Application-Specific Integrated Circuit (ASIC), etc. The general-purpose processor may be a microprocessor, or the processor may be any conventional processor or the like. The steps of the methods disclosed in the disclosure may be directly executed and completed by a hardware processor, or by a combination of hardware and software modules in the processor.

The memory may include high-speed RAM and may also include NVM, such as at least one disk storage device, and could also be in the form of USB flash drives, portable hard drives, read-only memory, disks, or optical discs, among others.

The bus may be an Industry Standard Architecture (ISA) bus, a Peripheral Component Interconnect (PCI) bus, an Extended Industry Standard Architecture (EISA) bus, etc. The bus can be divided into an address bus, a data bus, a control bus, etc. For ease of representation, the bus in the accompanying drawings of the disclosure is not limited to only one bus or one type of bus.

The aforementioned storage medium may be implemented by any type of volatile or non-volatile storage device or a combination thereof, such as Static Random Access Memory (SRAM), Electrically Erasable Programmable Read-Only Memory (EEPROM), Erasable Programmable Read-Only Memory (EPROM), Programmable Read-Only Memory (PROM), Read-Only Memory (ROM), magnetic memory, flash memory, magnetic disks, or optical disks. The storage medium may be any available medium that can be accessed by a general-purpose or special-purpose computer.

In one example, the storage medium is coupled to the processor, enabling the processor to read information from and write information to the storage medium. Of course, the storage medium may also be an integral part of the processor. The processor and the storage medium may reside in an Application-Specific Integrated Circuit (ASIC). Of course, the processor and the storage medium may also exist as discrete components in an electronic control unit or a main control device.

Those skilled in the art may understand that all or part of the steps in the methods of the foregoing embodiments may be implemented by hardware following program instructions. The aforementioned program may be stored in a computer-readable storage medium. When the program is executed, it performs the steps including the foregoing method embodiments. The storage medium includes various media that can store program codes, such as ROM, RAM, magnetic disks, or optical disks.

Finally, it should be noted that the above embodiments are only used to illustrate the technical solutions of the disclosure and are not intended to limit them. Although the disclosure has been described in detail with reference to the foregoing embodiments, those skilled in the art should understand that they may still modify the technical solutions described in the foregoing embodiments or make equivalent replacements to some or all of the technical features. However, these modifications or replacements do not cause the essence of the corresponding technical solutions to depart from the scope of the technical solutions of the embodiments of the disclosure.

What is claimed is:

1. A method for automatically identifying abnormal pollutant discharge permit information, comprising:
obtaining key parameter pairs, wherein the key parameter pairs are selected from enterprise pollutant discharge permit filing information, and each key parameter pair comprises a first key parameter and a second key parameter;
calculating, based on the key parameter pairs, a Pearson correlation coefficient matrix using a dynamic time window;
performing distribution statistics on the correlation coefficient matrix, and calculating a mathematical expectation and a confidence interval of correlation coefficients;
determining, based on the correlation coefficient matrix after the distribution statistics, the key parameter pairs that pass a distribution test, and based on the key parameter pairs passed the distribution test, calculating a ratio coefficient matrix using the dynamic time window, and calculating a mathematical expectation of the ratio coefficient matrix;
constructing an upper and lower edge value distribution function based on quantile regression of ratio coefficients;
filtering a plurality of groups of parameters for the upper and lower edge value distribution function of the ratio coefficients based on the key parameter pairs, the correlation coefficient matrix, the ratio coefficient matrix, and the mathematical expectation of the ratio coefficient matrix, and validating the plurality of groups of parameters to determine an optimal quantile distribution function; and
utilizing the optimal quantile distribution function to calculate upper and lower edge values of the ratio coefficients for the key parameter pairs, and identifying the abnormal pollutant discharge permit information based on the upper and lower edge values;
wherein the constructing an upper and lower edge value distribution function based on quantile regression of ratio coefficients comprises:
constructing a neural network model targeting quantiles as the upper and lower edge value distribution function based on the quantile regression, wherein the neural network model takes the key parameter pairs, the correlation coefficient matrix, and the ratio coefficient matrix as inputs, and takes the upper and lower edge values of the ratio coefficients for the key parameter pairs as outputs; and
using a quantile loss function as a loss function of the neural network model, wherein a target value of the quantile loss function is the mathematical expectation of the ratio coefficient matrix, and the quantile loss function comprises an individual quantile loss function and a grouped quantile loss function; and calculation formulas for the individual quantile loss function and the grouped quantile loss function are as follows:
$$loss ( {y}_{i} , {y}^{p} ) = q * max ( 0 , {y}_{i} - {y}^{p} ) + ( 1 - q )$$
$$loss ( y , {y}^{p} ) = \frac{1}{N} {\sum }_{i = 1}^{N} loss ( {y}_{i} , {y}^{p} )$$
where loss (yᵢ, y^{p}) represents the individual quantile loss function, y represents the target value, y^{p} represents a model predicted value, q represents a quantile level, yᵢ represents a single target value, loss (y, y^{p}) represents the grouped quantile loss function, N represents a total amount of the target value, and i represents that calculation has reached an i-th target value.

2. The method as claimed in claim 1, wherein the calculating, based on the key parameter pairs, a Pearson correlation coefficient matrix using a dynamic time window is expressed by the following formula:
$${ρ}_{x , {y}_{i = 1}^{m}} = \frac{{\sum }_{j = 1}^{n} ( {x}_{ij} - {μ}_{xi} ) ( {y}_{ij} - {μ}_{yi} )}{( n - 1 ) {σ}_{xi} {σ}_{yi}}$$
$${σ}_{xi} = \sqrt{\frac{{\sum }_{j = 1}^{n} {( {x}_{ij} - {μ}_{xi} )}^{2}}{n - 1}}$$
$${σ}_{yi} = \sqrt{\frac{{\sum }_{j = 1}^{n} ( {y}_{ij} - {μ}_{yi} )}{n - 1}}$$
where
$${ρ}_{x , {y}_{i = 1}^{m}}$$
represents an element of the Pearson correlation coefficient matrix, xᵢⱼ represents the first key parameter of a j-th key parameter pair in an i-th dynamic time window, μₓᵢ represents an arithmetic mean value of the first key parameter in the i-th dynamic time window, n represents a length of the parameter pairs, j represents that calculation has reached the j-th parameter pair, yᵢⱼ represents the second key parameter of the j-th key parameter pair in the i-th dynamic time window, μ_{yi} represents an arithmetic mean value of the second key parameter in the i-th dynamic time window, σₓᵢ represents a variance of the first key parameter in the i-th dynamic time window, σ_{yi} represents a variance of the second key parameter in the i-th dynamic time window, and m represents a number of sliding windows.

3. The method as claimed in claim 1, wherein the performing distribution statistics on the correlation coefficient matrix, and calculating a mathematical expectation and a confidence interval of correlation coefficients comprises:
performing fitting distribution on the correlation coefficient matrix based on a Gaussian distribution to obtain fitted data;
performing a distribution test based on a Kolmogorov-Smirnov (K-S) test on the fitted data, and when the distribution test passes, determining that the correlation coefficient matrix conforms to the Gaussian distribution, wherein the K-S test is calculated as follows:
$${D}_{n} = \begin{matrix}sup \\ x\end{matrix} \vert {F}_{n} ( x ) - F ( x ) \vert$$
where Dₙ represents statistic of the K-S test,
$$\begin{matrix}sup \\ x\end{matrix}$$
represents a supremum of a distance of a computed sequence, Fₙ(x) represents a value of a sequence to be tested, and F(x) represents a theoretical distribution sequence value;
for the correlation coefficient matrix conforming to the Gaussian distribution, calculating the mathematical expectation and the confidence interval of the correlation coefficient matrix; wherein the mathematical expectation is E(X)=μ, and the confidence interval is μ±σ, μ is a general expression for an arithmetic mean value, and σ represents a variance calculated from data.

4. The method as claimed in claim 3, wherein the determining, based on the correlation coefficient matrix after the distribution statistics, the key parameter pairs that pass a distribution test, and based on the key parameter pairs passed the distribution test, calculating a ratio coefficient matrix using the dynamic time window, and calculating a mathematical expectation of the ratio coefficient matrix comprises:
taking the key parameter pairs corresponding to the correlation coefficient matrix that conforms to the Gaussian distribution as the key parameter pairs passed the distribution test;
based on the key parameter pairs passed the distribution test, calculating the ratio coefficient matrix K, wherein elements of K are composed of
$${k}_{x , {y}_{i = 1}^{m}} , {k}_{x , {y}_{i = 1}^{m}} = \frac{{\vec{x}}_{i}}{{\vec{y}}_{i}} ;$$
\vec{x}ᵢ represents a vector of the first key parameter in the key parameter pair, and \vec{y}ᵢ represents a vector of the second key parameter in the key parameter pair;
performing distribution fitting statistics on the ratio coefficient matrix to obtain a fitted ratio coefficient matrix, using one of the Gaussian distribution, a Poisson distribution, or an exponential distribution;
performing the distribution test on the fitted ratio coefficient matrix using any one of the K-S test, an Anderson-Darling (A-D) test, or a t-test; and
calculating the mathematical expectation of the ratio coefficient matrix passed the distribution test.

5. The method as claimed in claim 1, wherein the filtering a plurality of groups of parameters for the upper and lower edge value distribution function of the ratio coefficients based on the key parameter pairs, the correlation coefficient matrix, the ratio coefficient matrix, and the mathematical expectation of the ratio coefficient matrix, and validating the plurality of groups of parameters to determine an optimal quantile distribution function comprises:
establishing a dataset based on the key parameter pairs, the correlation coefficient matrix, the ratio coefficient matrix, and the mathematical expectation of the ratio coefficient matrix;
dividing the dataset into a plurality of groups of training sets, testing sets, and validation sets; wherein the validation sets are randomly extracted from the dataset, and the target value of the quantile loss function is an overall mathematical expectation of the ratio coefficient matrix; the training sets and the testing sets are obtained via a sliding window from the remaining data after extracting the validation sets;
optimizing the parameters of the upper and lower edge value distribution function of the ratio coefficients using the training sets, and when an evaluation metric of the upper and lower edge value distribution function of the ratio coefficients on the testing sets meets a standard, determining filtered parameters and proceeding to filter a next group of parameters; and
for a plurality of filtered parameters of the upper and lower edge value distribution function of the ratio coefficients, validating, on the validation sets, evaluation metrics of the plurality of filtered parameters of the upper and lower edge value distribution function of the ratio coefficients, selecting one group of parameters with an optimal evaluation metric as target parameters, configuring the upper and lower edge value distribution function of the ratio coefficients with the target parameters, and thereby obtaining the optimal quantile distribution function;
wherein the evaluation metric is prediction interval coverage probability (PICP), with a prediction interval confidence level (PINC), and the calculation formula is as follows:
$$PICP = \frac{1}{N} {\sum }_{i = 1}^{N} {c}_{i}$$
$${c}_{i} = \{ \begin{matrix}1 , & {y}_{i} ∈ [ L , U ] \\ 0 , & {y}_{i} ∉ [ L , U ]\end{matrix}$$
$$PINC = 100 ( 1 - α ) \%$$
where L represents a predicted lower edge value, U represents a predicted upper edge value, N represents a total amount of computed data, i represents an i-th data point, cᵢ represents a numerical expression indicating whether an actual value falls within a predicted interval, yᵢ represents an i-th actual value, and α represents a confidence level.

6. An apparatus for automatically identifying abnormal pollutant discharge permit information, comprising:
a data acquisition module, configured to obtain key parameter pairs, wherein the key parameter pairs are selected from enterprise pollutant discharge permit filing information, and each key parameter pair comprises a first key parameter and a second key parameter;
a first calculation module, configured to calculate, based on the key parameter pairs, a Pearson correlation coefficient matrix using a dynamic time window;
a distribution verification module, configured to perform distribution statistics on the correlation coefficient matrix, and calculating a mathematical expectation and a confidence interval of correlation coefficients;
a second calculation module, configured to determine, based on the correlation coefficient matrix after the distribution statistics, the key parameter pairs that pass a distribution test, and based on the key parameter pairs passed the distribution test, calculating a ratio coefficient matrix using the dynamic time window, and calculating a mathematical expectation of the ratio coefficient matrix;
a function construction module, configured to an upper and lower edge value distribution function based on quantile regression of ratio coefficients;
a function training module, configured to filter a plurality of groups of parameters for the upper and lower edge value distribution function of the ratio coefficients based on the key parameter pairs, the correlation coefficient matrix, the ratio coefficient matrix, and the mathematical expectation of the ratio coefficient matrix, and validating the plurality of groups of parameters to determine an optimal quantile distribution function; and
an anomaly identification module, configured to utilize the optimal quantile distribution function to calculate upper and lower edge values of the ratio coefficients for the key parameter pairs, and identifying the abnormal pollutant discharge permit information based on the upper and lower edge values;
wherein the constructing an upper and lower edge value distribution function based on quantile regression of ratio coefficients comprises:
constructing a neural network model targeting quantiles as the upper and lower edge value distribution function based on the quantile regression, wherein the neural network model takes the key parameter pairs, the correlation coefficient matrix, and the ratio coefficient matrix as inputs, and takes the upper and lower edge values of the ratio coefficients for the key parameter pairs as outputs; and
using a quantile loss function as a loss function of the neural network model, wherein a target value of the quantile loss function is the mathematical expectation of the ratio coefficient matrix, and the quantile loss function comprises an individual quantile loss function and a grouped quantile loss function; and calculation formulas for the individual quantile loss function and the grouped quantile loss function are as follows:
$$loss ( {y}_{i} , {y}^{p} ) = q * max ( 0 , {y}_{i} - {y}^{p} ) + ( 1 - q )$$
$$loss ( y , {y}^{p} ) = \frac{1}{N} {\sum }_{i = 1}^{N} loss ( {y}_{i} , {y}^{p} )$$
where loss (yᵢ, y^{p}) represents the individual quantile loss function, y represents the target value, y^{p} represents a model predicted value, q represents a quantile level, yᵢ represents a single target value, loss (y, y^{p}) represents the grouped quantile loss function, N represents a total amount of the target value, and i represents that calculation has reached an i-th target value.

7. An electronic device, comprising: a processor, and a memory communicatively connected to the processor;
wherein the memory stores computer-executable instructions;
wherein the processor executes the computer-executable instructions stored in the memory to implement the method as claimed in claim 1.

8. A computer-readable storage medium, wherein the computer-readable storage medium stores computer-executable instructions, when executed by a processor, causing the processor to implement the method as claimed in claim 1.

9. A computer program product, comprising a computer program, when executed by a processor, implementing the method as claimed in claim 1.
